(19) United States
(12) Patent Application Publication
(10) Pub. No.: US 2013/0245687 A1
(43) Pub. Date: Sep. 19, 2013

(54) Teething Tip

(71) Applicant: Kimberly Bachmann, Linden, NJ (US)

(72) Inventor: Kimberly Bachmann, Linden, NJ (US)

(21) Appl. No.: 13/846,988

(22) Filed: Mar. 19, 2013

Related U.S. Application Data
(60) Provisional application No. 61/612,487, filed on Mar. 19, 2012.

(51) Int. Cl. A61J 17/00

(52) U.S. Cl. CPC A61J 17/00
USPC 606/235

(57) ABSTRACT

A teething device for a baby is described. The device is a textured flexible cover for an adult's finger. The adult may place the finger covered by the device into the baby's mouth, allowing the baby to bite down on the teething device, thus alleviating teething pain for the baby and finger pain for the adult. The teething device may be frozen or heated. It may also be infused or coated with flavors or medications.

### CLAIM OF PRIORITY

This application claims priority to U.S. Ser. No. 61/612,487 filed Mar. 19, 2012, the contents of which are fully incorporated herein by reference.

### FIELD OF THE INVENTION

The invention relates to a teething device for infants and toddlers.

### BACKGROUND OF THE INVENTION

The invention relates to a teething device for infants and toddlers. Infants and toddlers (babies) often experience pain when their teeth are erupting through their gums, a process called ‘teething.’ Although many teething devices have been made for babies, many babies still prefer to use their caregiver's fingers to comfort their sore gums. Often times a baby will pull a caregiver's finger into his mouth and place it on the sore gum, even when other teething devices are available to him. This can cause pain to the caregiver if the baby bites down on the finger, and may frustrate the baby when the caregiver takes his finger away. It may also introduce germs into the baby's mouth and make him sick. The present invention overcomes these difficulties with a unique, ingenious device.

The relevant prior art involving dental and teething devices includes:

U.S. Pat. No. 1,023,822, ‘Teething-Finger’ describes a teething device in the shape of a finger comprising a hard core covered by a soft material.

U.S. Pat. No. 2,688,961, ‘Multipurpose Finger-Attached Assembly’ describes a multi-purpose finger-attached accessory for application to a thumb or one of the fingers of a small child's hand comprising an expansible and contractile finger-stall provided on its outer usable end with a compressibly resilient teething ring with means designed safely to forestall and hinder the act of the wearer of putting a predetermined finger into the mouth and to in this manner frustrate the wearer and to consequently minimize finger sucking, said means embodying a teething ring.

U.S. Pat. No. 2,112,184, ‘Double Pressure Interdental Wedge Gum Massager’ describes an inter-dental tissue pressure massaging device comprising a finger-engaging means, and a soft pliable means projecting therefrom for conforming to the contour of the space between the approximating teeth when pressure is exerted thereon to permit the massaging device to reach the deep inter-dental tissues of the gums.

US Patent Application No. 20050210652, ‘Oral Motor Therapy Device’ includes a device having a plurality of connected finger covers. The finger covers are preferably configured to be worn by a user around at least two of the user's fingers. The device also preferably has at least two sets of protrusions. Each set of protrusions is preferably connected to a finger cover and is configured to provide a different tactile sensation from the other set of protrusions. With the device of the present invention, the user may switch between the two sets of protrusions when providing tactile sensation to a person by moving the finger to which the desired set of protrusions is connected.

Various implements are known in the art, but fail to address all of the problems solved by the invention described herein. Embodiments of this invention are illustrated in the accompanying drawings and will be described in more detail herein below.

### SUMMARY OF THE INVENTION

In a preferred embodiment, the present invention is an article of manufacture, comprising a tapered cylinder, said tapered cylinder having a closed end and an open end, said tapered cylinder having an inner surface and an outer surface wherein said outer surface has a texture, said tapered cylinder being comprised of a material, wherein said material is impervious to the forces imposed by biting, and said material securely adheres to a finger.

The tapered cylinder fits over the finger of an adult. When a baby is teething, he may desire to grab the adult's finger and place it in his mouth, or the adult may place her own finger in the baby's mouth. The tapered cylinder provides protection for the adult's finger and also protects the baby from germs that may be on the unprotected finger. In addition, the tapered cylinder may be coated or impregnated with pain-relieving medication, thus making the medication easier to apply.

Therefore, the present invention succeeds in conferring the following, and others not mentioned, desirable and useful benefits and objectives.

It is an object of the present invention to provide teething relief for a baby.

It is another object of the present invention to provide a biting surface for a baby that is similar to a caretaker's finger.

Yet another object of the present invention is to provide a hygienic biting surface for a baby.

Still another object of the present invention is to provide a safe biting surface for a baby.

Still another object of the present invention is to allow a baby to bite a caregiver's finger without causing pain to the caregiver.

Yet another object of the present invention is to provide a device for applying medication to a baby's gums.

### BRIEF DESCRIPTION OF THE DRAWINGS

FIG. 1 is a front perspective view of the present invention in use.

FIG. 2a is a front view of the invention.

FIG. 2b is a back view of the invention.

FIG. 2c is a top view of the invention.

FIG. 2d is a bottom view of the invention.

FIG. 2e is a side view of the invention.

FIG. 2f is a side view of the invention.

FIG. 3a is a side cut-away view of the invention with a single layer of material.

FIG. 3b is a side cut-away view of the invention with a double layer of material.

FIG. 4 is a front cut-away view of the invention with water disposed between two layers of material.

FIG. 5a is a front view of an embodiment of the invention as a set.

FIG. 5b is a back view of an embodiment of the invention as a set on a set of fingers.

FIG. 6 is a front view of an alternate embodiment of the invention.

FIG. 7 is a front view of an additional alternate embodiment of the invention.

FIG. 8 is a front view of an additional alternate embodiment of the invention.

FIG. 9 is a back view of the embodiment shown in FIG. 8.

FIG. 10 is a front view of an additional alternate embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

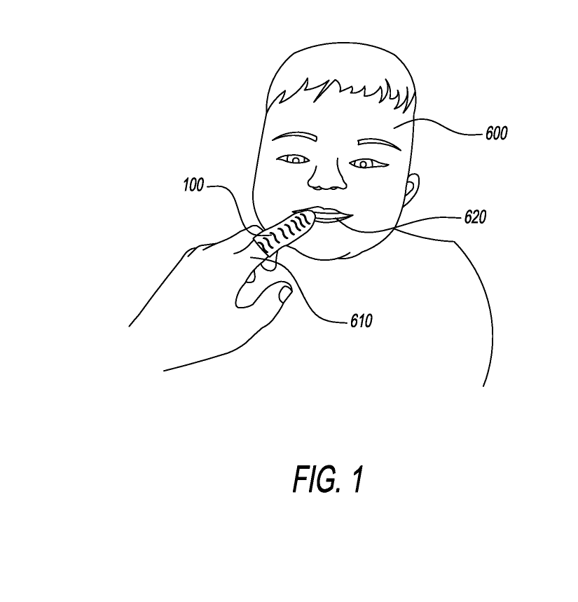

FIG. 1 is a front perspective view of the present invention in use. FIG. 1 shows the tapered cylinder 100 on a caregiver's finger 610, a baby 600, and the baby's mouth 620. The caregiver has put the tapered cylinder 100 on her own finger and is inserting her finger into the baby's mouth 620. The baby may direct the caregiver's finger to any part of his mouth, and may bite down on the caregiver's finger without causing damage. The caregiver may run her finger through the baby's mouth to find emerging teeth and may massage that part of the gum, or she may already know where the teeth are emerging so she can massage and/or apply medication directly to the painful spot in the baby's mouth.

After use, the caregiver may remove the tapered cylinder and wash it and/or disinfect it in any way she wishes, for instance by boiling, bleaching, washing it in the dishwasher, etc. Unlike a human finger, the tapered cylinder can withstand more harsh forms of germ-killing, and may be subjected to them repeatedly without the pain and/or chafing that a finger would endure with repeated washings.

The tapered cylinder may be made from any material, including but not limited to, rubbers, such as but not limited to, silicone rubber and natural gum rubber; thermoplastics, such as but not limited to ethylene vinyl acetate (EVA); plastics; elastomers; thermoplastic elastomers; paper or wood materials; metals; glass materials, such as but not limited to, gorilla glass or fiberglass; textiles, such as but not limited to, cotton, silk, viscose, modal, wool, soy fabric, or bamboo; animal components, such as but not limited to, leather or fur; and any materials or any combination of these materials with each other or any other materials. One or more materials may be used in differing places on the tapered cylinder, for instance the outer surface may be EVA while the inner surface is cotton, or the tip may be made from EVA while the lower portion is made from bamboo, or a combination of these.

It is preferred that the tapered cylinder material is flexible. Preferred materials of manufacture for the tapered cylinder are EVA, rubber, silicone, and cotton. Also preferred is that the materials of manufacture be non-toxic, BPA-free, PVC-free, Phthalate-free, and lead-free.

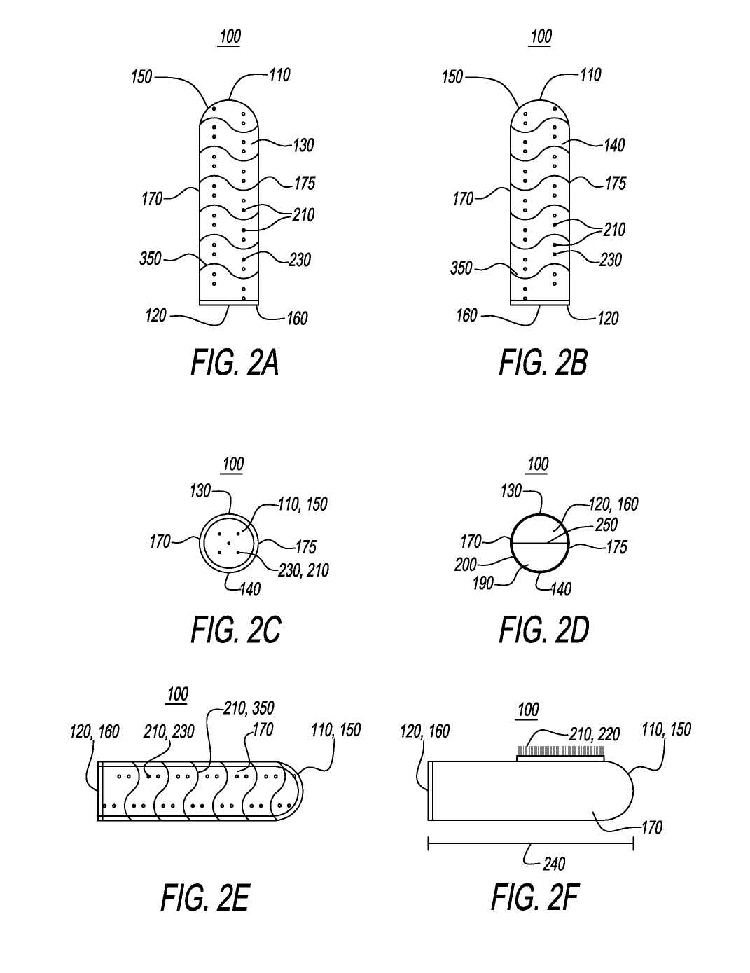

FIGS. 2a-2f illustrate a preferred embodiment of the invention.

FIG. 2a is a front view of the invention. FIG. 2a shows the tapered cylinder 100, with closed end 110, open end 120, front 130, top 150, bottom 160, first side 170, second side 175, texture 210, bumps texture 230, and squiggle texture 350.

FIG. 2b is a back view of the invention. FIG. 2b shows the tapered cylinder 100, with closed end 110, open end 120, back 140, top 150, bottom 160, first side 170, second side 175, texture 210, bumps texture 230, and squiggle texture 350.

FIG. 2c is a top view of the invention. FIG. 2c shows the tapered cylinder 100, with closed end 110, front 130, back 140, top 150, first side 170, second side 175, texture 210, and bumps texture 230.

FIG. 2d is a bottom view of the invention. FIG. 2d shows the tapered cylinder 100, with open end 120, front 130, back 140, bottom 160, first side 170, second side 175, inner surface 190, outer surface 200, and tapered cylinder diameter 250.

FIG. 2e is a side view of an embodiment of the invention. FIG. 2e shows the tapered cylinder 100, with closed end 110, open end 120, top 150, bottom 160, first side 170, texture 210, bumps texture 230, and squiggles texture 350.

FIG. 2f is a side view of an embodiment of the invention. FIG. 2f shows the tapered cylinder 100, with closed end 110, open end 120, top 150, bottom 160, first side 170, texture 210, bristles 220, and tapered cylinder full length 240.

FIGS. 2a-2f show the tapered cylinder 100 in detail. The tapered cylinder has a closed end 110 and an open end 120. The user places his finger into the open end of the tapered cylinder and pulls on it until it slides all the way onto his finger. Alternately, depending on the flexibility of the material of manufacture, the user may roll the tapered cylinder up, place the closed end 110 on his finger tip, and unroll the tapered cylinder down his finger. The tapered cylinder fits snugly on the user's finger.

The dimensions of the tapered cylinder full length are such that it fits on most of an adult's finger, extending most of the way to the hand. The preferred material of manufacture is flexible, such that it stretches and contracts to fit a range of finger sizes. The tapered cylinder full length 240 shown in FIG. 2f may be from 2 to 10 centimeters, with the preferred length being approximately 5 to 6.5 centimeters. The tapered cylinder diameter 250 shown in FIG. 2d may be from 1 to 6 centimeters, with the preferred diameter being approximately 2.5 centimeters.

The tapered cylinder preferably has a texture 210. The texture may be any type of texture. Textures shown in FIGS. 2a-2f include a bumps texture 230 and a squiggles texture 350 in FIGS. 2a, 2b and 2e, a bumps texture 230 in FIG. 2c, and a bristles texture 230 in FIG. 2f. The textures would allow further protection for the caregiver when the baby bites down, and also allow the baby a textured teething surface. The texture 210 may be on the entire tapered cylinder 210 as shown in FIGS. 2a-2c and 2e, or it may be on a part of the tapered cylinder, as shown in FIG. 2f. It may also be on one or more parts of the tapered cylinder.

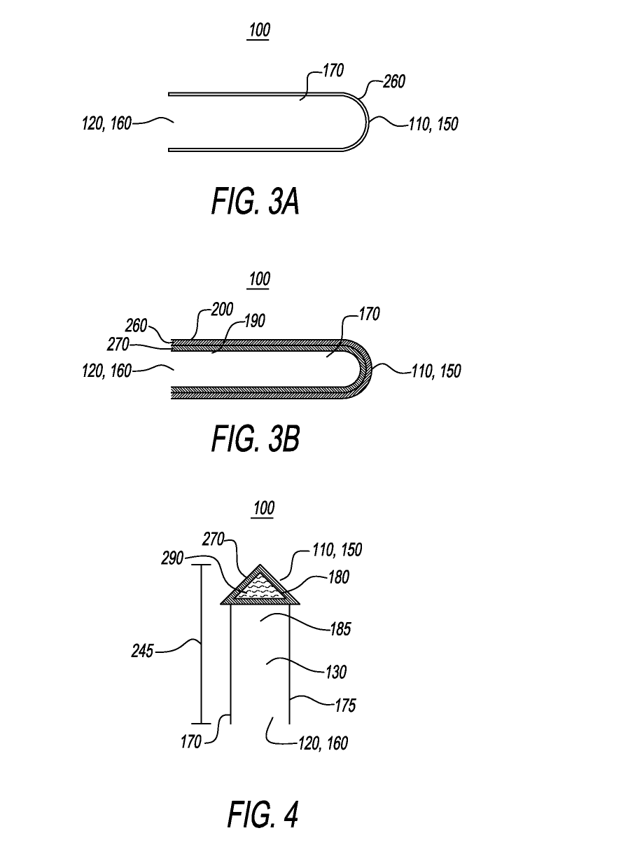

FIGS. 3a-3b illustrate the invention with varying layers of material.

FIG. 3a is a side cut-away view of the invention with a single layer of material. FIG. 3a shows the tapered cylinder 100, with closed end 110, open end 120, top 150, bottom 160, first side 170, and first layer 260.

FIG. 3b is a side cut-away view of the invention with a double layer of material. FIG. 3b shows the tapered cylinder 100, with closed end 110, open end 120, top 150, bottom 160, first side 170, inner surface 190, outer surface 200, first material layer 260, and second material layer 270.

FIGS. 3a-3b show the tapered cylinder made from varying layers of material. In FIG. 3a one layer of material is used, in FIG. 3b two layers are used, but any number of layers of material may be used for the tapered cylinder. The layers may be made from any of the materials described with FIG. 1, and from any liquid or gel, including but not limited to, water, medication, or any other liquid or gel. For instance, the middle layer may be pain medication that slowly seeps through pores in one of both of the outer layers.

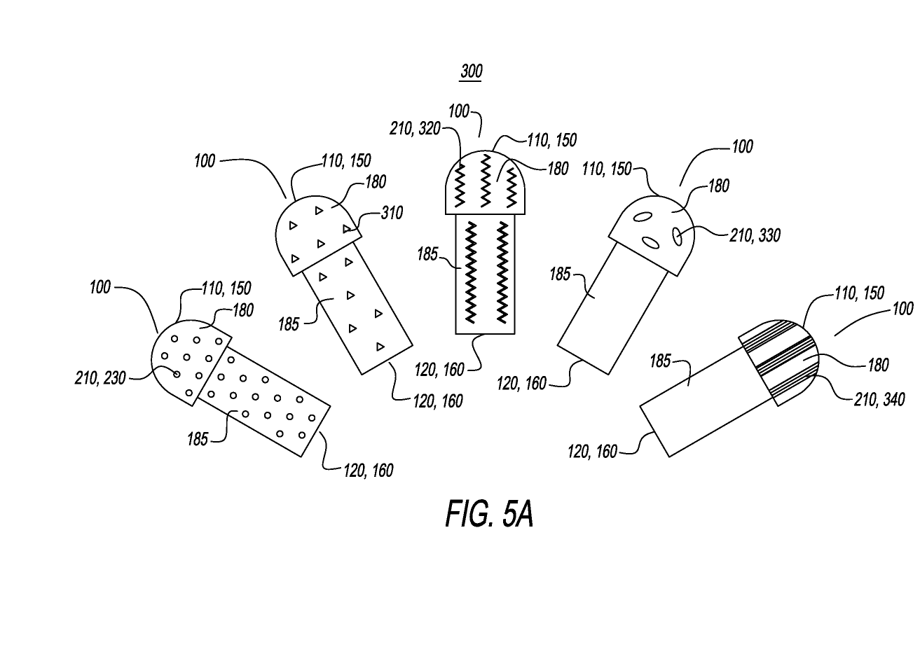

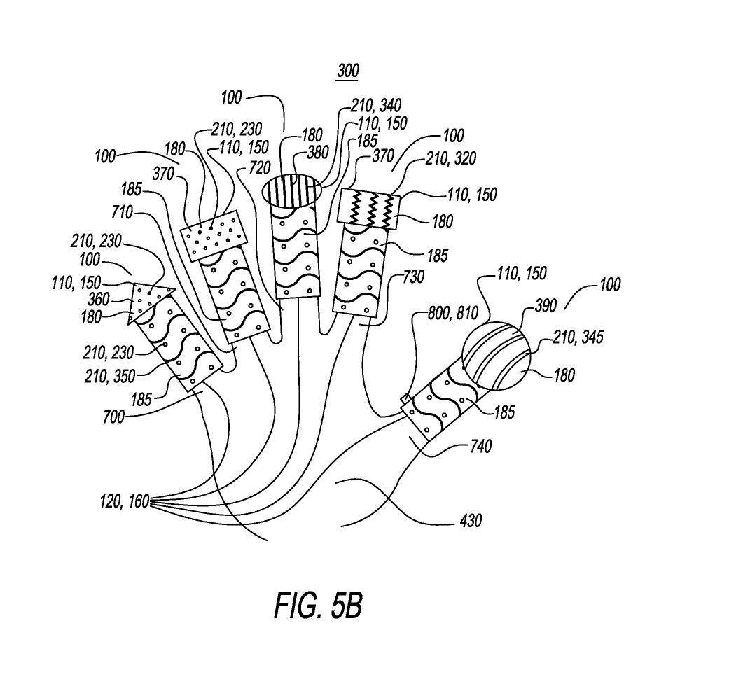

FIG. 4 is a front cut-away view of the invention with water disposed between two layers of material in a tip. Because it is a cut-away view, the top material layer is not shown. In FIG. 4 three total layers of materials are used, with the middle layer being water. The tip will be discussed in more detail with FIGS. 5a-b. FIG. 4 shows the tapered cylinder 100, with closed end 110, open end 120, front 130, top 150, bottom 160, first side 170, second side 175, tip 180, lower portion 185, tapered cylinder partial length 245, second material layer 270, and liquid layer 290.

In FIG. 4, the tip 180 contains a liquid or gel. The liquid or gel is preferably water. The amount of liquid or gel used would depend on the size of the tip 180; it would be enough to give a cushion between the first and second material layers so the baby would bite down on a soft, resilient surface.

Although shown with liquid or gel disposed between the first and second material layers of the tip 180, water or other liquid or gel could be disposed between the first and second material layers of the lower portion 185 as well. The liquid or gel could be disposed solely in the tip 180, solely in the lower portion 185, or in both the tip and lower portion, or in any part of the tip or lower portion.

The tapered cylinder 100 may be made such that it can be frozen or heated; in the case of freezing, the water in the tip 180 would become ice or slush, which could be used to soothe a teething baby. If water is used as the liquid and the tapered cylinder is designed to be frozen, enough space would be left between the first and second material layers for the water to expand when frozen into ice.

FIG. 4 also shows a tapered cylinder partial length 245, designed to partially fit over a finger, ending at about the second knuckle. The tapered cylinder partial length may be from 2 to 10 centimeters in length, with a preferred length of 4 to 7.5 centimeters.

The tapered cylinder can be any length to fit over any portion of the finger. For instance, it may be desirable to have a length that fits over the finger just to the first knuckle, or to somewhere between the first and second knuckle, or to a spot between the second knuckle and the hand. Additionally, the tapered cylinder will fit different fingers in different ways, extending to differing spots on the finger depending on the wearer. Because it is flexible, it can stretch to fit a wide range of adult fingers.

FIGS. 5a-5b illustrate an embodiment of the present invention as a set. FIGS. 5a-5b show a set of tapered cylinders, with tips 180 on the closed ends 110. The set of tapered cylinders is comprised of each tapered cylinder having a closed end and an open end; each tapered cylinder having an inner surface and an outer surface wherein said outer surface has a texture; each tapered cylinder being comprised of a material, wherein said material is impervious to the forces imposed by biting; and said material securely adheres to a finger.

FIG. 5a is a front view of an embodiment of the invention as a set. FIG. 5a shows a set of tapered cylinders 300, with tapered cylinders 100, with closed ends 110, open ends 120, tops 150, bottoms 160, tips 180, lower portions 185, texture 210, bumps texture 230, triangles texture 310, zigzag texture 320, oblong texture 330, and ridged line texture 340.

FIG. 5b is a back view of an embodiment of the invention as a set on a set of fingers. Also shown in FIG. 5b is a battery and switch to enable vibration in the tapered cylinder or tip. FIG. 5b shows a set of tapered cylinders 300, with tapered cylinders 100, with closed ends 110, open ends 120, tops 150, bottoms 160, tips 180, lower portions 185, texture 210, bumps texture 230, zigzag texture 320, ridged line texture 340, grooves texture 345, squiggle texture 350, triangle shape 360, rectangle shape 370, oblong shape 380, and circular shape 390. Also shown is hand 430, with pinky finger 700, ring finger 710, middle finger 720, pointer finger 730, thumb 740, vibrating switch 800, and battery 810.

FIGS. 5a and 5b illustrate part of the wide range of textures that can be used. As can be seen in FIG. 5a, the texture may be the same on the tip 180 as on the lower portion 185, or it may be different. Each tapered cylinder of the set may have a different design, or they may all be the same. The tapered cylinders in the set are interchangeable, so any tapered cylinder can be worn on any finger. The texture may also be indicia, such as but not limited to, letters, characters, shapes, logos, pictures, or any of these in combination with each other or other textures.

FIG. 5b illustrates the set of tapered cylinders on a hand. The user may dispose tapered cylinders on all five fingers as shown, or may use part of the set, for instance, only disposing tapered cylinders on three of the fingers. The tapered cylinders may be disposed on any number and combination of fingers, on either hand or on both hands at once.

The tips may be any shape; as can be seen in the figures, the tip 180 on the pinky finger 700 is triangular shaped, the tips 180 on the ring finger 710 and the pointer finger 730 are rectangular shaped, the tip on the middle finger 720 is oblong shaped, and the tip on the thumb 740 is circular shaped. Although shown with these specific shapes, any other shapes may be used. For instance, there may be a shape that is superior for reaching into a baby's mouth and contacting a specific spot in the mouth, and this shape may be used on one or more fingers as part of one or more tapered cylinders.

The set of tapered cylinders may include identical tapered cylinders, or a combination of different tapered cylinders. For instance, a set of tapered cylinders may include one tapered cylinder that vibrates, one tapered cylinder that has an extended shape, one tapered cylinder that contains a water layer, and one tapered cylinder that has a bristles texture. Although the set of tapered cylinders preferably has five tapered cylinders, a set of tapered cylinders may be any number of tapered cylinders, from two tapered cylinders to fifty tapered cylinders, with each tapered cylinder being unique to the set, each tapered cylinder being the same in the set, or any combination thereof.

The tips 180 and the lower portions 185 may be made from the same or differing materials; they are preferably one continuous piece. The material of the tips may be thicker than the material of the lower portions, thereby making it easier to dispose the tapered cylinder onto a finger while providing a thick surface for a baby to bite down on. The thickness of the lower portions may preferably be from 0.001 mm to 20 mm, and the thickness of the tips may preferably be from 0.001 to 40 mm. The tips may be designed and shaped such that they can be easily disposed in a baby's mouth; for instance, a tip may be elongated and narrowed so it can reach to the back of the baby's mouth.

The tapered cylinder may be any color or colors. The tips and the lower portions may be the same color, differing colors, and/or there may be designs or logos on the tapered cylinder, either covering the entire tapered cylinder or parts of it. Although specific shapes are shown for the tips, any shapes may be used, and they may be smaller or larger in relation to the lower portions than is illustrated in the figures.

FIG. 5b shows a vibrating switch 800. The tip may vibrate, or the entire tapered cylinder may vibrate. The vibration may be started and stopped using the switch 800. The switch may also control the rate of vibration. The vibration may be powered by any power source, preferably a battery, such as but not limited to a button cell battery, which may be either internal or external to the tapered cylinder.

The dimensions of the tapered cylinders in the set may all be the same, and are as described with FIG. 1, or they may vary according to specific finger. For instance, the length for the thumb may be 2.5 inches (6.3 cm), the length for the pointer finger may be 3 inches (7.6 cm), the length for the middle finger may be 3 to 3.5 inches (7.6-8.9 cm), the length for the ring finger may be 3 inches (7.6 cm), and the length for the thumb may be 2.5 inches (6.3 cm) for a tapered cylinder full length; the lengths may be corresponding less for the tapered cylinder partial length.

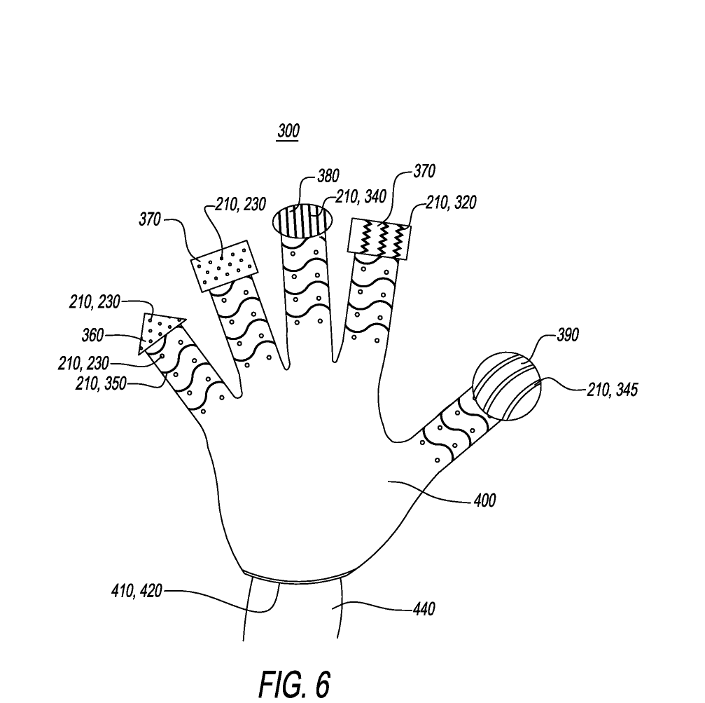

FIG. 6 illustrates a further embodiment of the present invention, a set of tapered cylinders joined by a sheath; said sheath having an open end; each tapered cylinder having an inner surface and an outer surface wherein said outer surface has a texture; each tapered cylinder being comprised of a material, wherein said material is impervious to the forces imposed by biting; and said sheath securely adheres to a hand.

FIG. 6 is a front view of an embodiment of the invention. FIG. 6 shows a set of tapered cylinders 300, with texture 210, bumps texture 230, zigzag texture 320, ridged line texture 340, grooves texture 345, squiggle texture 350, triangle shape 360, rectangle shape 370, oblong shape 380, and circular shape 390. The tapered cylinders are joined by a sheath 400, which has sheath open end 410, and sheath bottom 420, and which fits over the hand and ends at wrist 440.

FIG. 6 shows an embodiment of the invention in which the set of tapered cylinders is joined by a sheath, which acts as a glove. This allows an extra amount of security, in that the tapered cylinders are anchored onto the adult's hand by both the quality of the tapered cylinder conforming to the fingers and the sheath conforming to the hand. Although shown with five tapered cylinders, this embodiment may have one to five tapered cylinders; the fingers not covered by tapered cylinders may be covered by cloth or other materials, or may be bare. The sheath may be made from the same or differing materials as the tapered cylinders; it may be all one continuous piece, as shown in the figure, or the tapered cylinders may be detachable from the sheath. The sheath may go over one or both sides of the hand. For instance, the sheath may only cover the back of the hand, or it may only cover the palm of the hand.

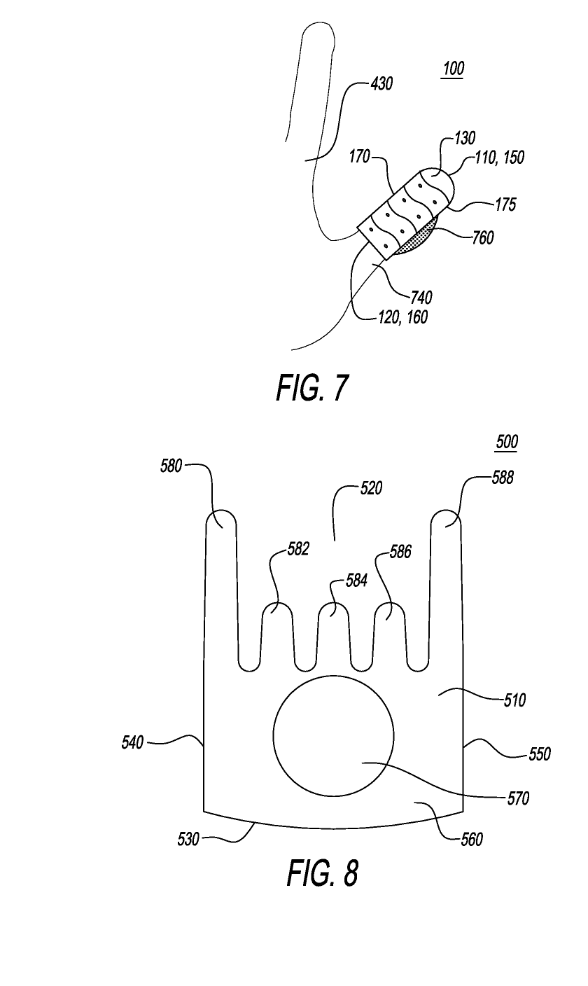

FIG. 7 illustrates a further embodiment the present invention.

FIG. 7 is a front view of an alternate embodiment of the invention. FIG. 7 shows the tapered cylinder 100, with closed end 110, open end 120, front 130, top 150, bottom 160, first side 170, second side 175, hand 430, thumb 740, and thumb guard 760.

FIG. 7 illustrates a thumb guard for the adult's thumb. This would give extra protection to the adult's thumb from the baby biting down, and would keep the thumb from extending too far into the baby's mouth. It may be made of any of the materials described with FIG. 1, and may be made from one or from multiple layers. It may be fluid or gel filled, using the same materials as for the tips described in FIG. 4.

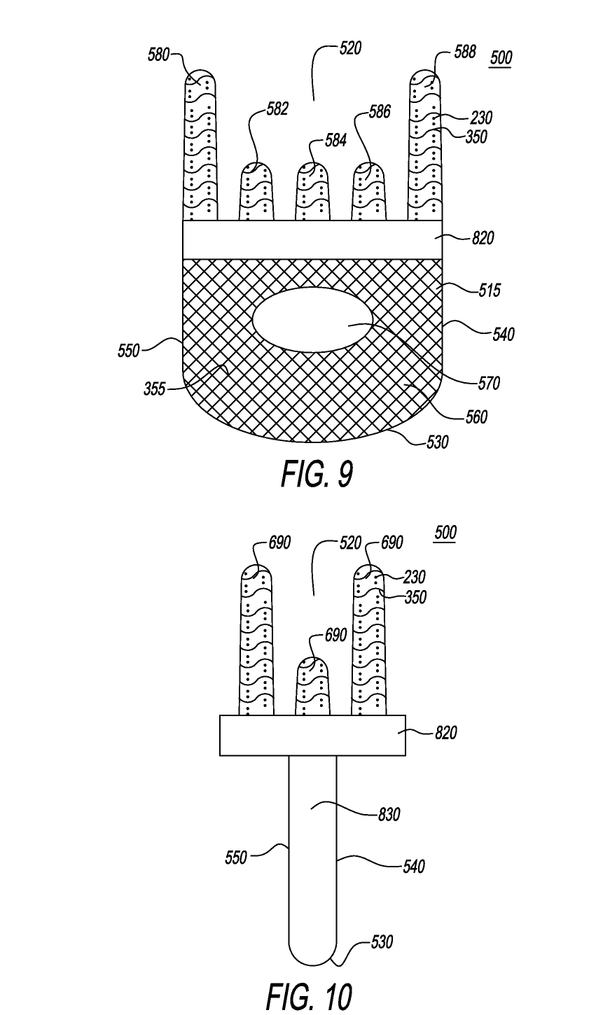

FIGS. 8-9 illustrate an alternate embodiment of the present invention. FIG. 8-9 show a holdable device with a hole in the lower third of the device and a plurality of fingers at the top of the device; said holdable device having a front side and a back side; each side having a texture; and said holdable device being comprised of a material, wherein said material is impervious to the forces imposed by biting.

FIG. 8 is a front view of an additional alternate embodiment of the invention. FIG. 8 shows a holdable device 500, with holdable device front 510, holdable device top 520, holdable device bottom 530, holdable device first side 540, holdable device second side 550, holdable device lower portion 560, holdable device hole 570, holdable device first finger 580, holdable device second finger 582, holdable device third finger 584, holdable device fourth finger 586, holdable device fifth finger 588.

FIG. 8 illustrates a device that the baby could hold onto himself. The holdable device hole 570 allows the baby to grasp the device by putting his fingers through it. He could then insert the fingers into his own mouth, or an adult could grasp the device and insert it into the baby's mouth.

The holdable device would be made of the same materials described with FIG. 1. There could be any number of fingers, and they could have any texture. Although shown with the device first finger 580 and the device fifth finger 588 longer than the device second, third, and fourth fingers, any of the fingers could be longer or shorter than the others. For instance, the second and fourth fingers may be longer than the first, third, and fifth fingers; ie: the plurality of fingers may comprise fingers of differing lengths. Alternately, the plurality of fingers may comprise fingers all of the same length.

There could be one or multiple material layers, and one or more of the layers could be made of the materials described with FIG. 1 or could be water or liquids or gels. The holdable device may be comprised of two layers with water disposed between the layers. Other configurations of layers and liquids and/or gels may also be used.

The holdable device may have a texture; the texture may be disposed on the holdable device front 510, holdable device top 520, holdable device bottom 530, holdable device first side 540, holdable device second side 550, holdable device lower portion 560, holdable device hole 570, holdable device first finger 580, holdable device second finger 582, holdable device third finger 584, holdable device fourth finger 586, and holdable device fifth finger 588, or any of these components separately or in various combinations. Differing textures may be used on different components, or one texture may be used on some components while a different texture is used on a different component.

FIG. 9 is a back view of the embodiment shown in FIG. 8. FIG. 9 shows a holdable device 500, with holdable device back 515, holdable device top 520, holdable device bottom 530, holdable device first side 540, holdable device second side 550, holdable device lower portion 560, holdable device hole 570, holdable device first finger 580, holdable device second finger 582, holdable device third finger 584, holdable device fourth finger 586, holdable device fifth finger 588, bumps texture 230, squiggle texture 350, cross hatch texture 355, and device guard 820.

As can be seen in FIG. 9, a device guard may be added to keep the baby from putting the holdable device too far into his mouth or down his throat. The holdable device hole 570 is also smaller than in FIG. 8; the hole may be any size or shape, as long as the baby can hold the holdable device. The holdable device hole may also be disposed anywhere in the holdable device lower portion 560.

FIG. 9 also illustrates how different textures may be used on differing parts of the device. The bumps texture and squiggles texture are disposed on the fingers of the holdable device, while a cross-hatch texture is disposed on the holdable device lower portion 560.

FIG. 10 is a front view of an additional alternate embodiment of the invention. FIG. 10 shows an article of manufacture, comprising a holdable device with a plurality of fingers at the top of the device; said holdable device having a front side and a back side; each side having a texture; and said holdable device having a device guard; and said holdable device being comprised of a material, wherein said material is impervious to the forces imposed by biting.

Illustrated in FIG. 10 is a holdable device 500, with holdable device top 520, holdable device bottom 530, holdable device first side 540, holdable device second side 550, finger 690, device guard 820, holdable device grasping surface 830, bumps texture 230, and squiggle texture 350.

The embodiment in FIG. 10 is meant to be grasped by the baby on the holdable device grasping surface 830, and he can then place one of the fingers 690 into his mouth. The device guard 820 prevents the baby from putting the holdable device too far into his mouth, thus preventing a choking hazard.

The fingers 690 may different or the same lengths. The fingers 690 may be solid or hollow, and may have water disposed between two or more layers of material. The materials of manufacture are the same as those described with FIG. 1. The fingers 690 may be made of flexible material while the device guard and holdable device grasping surface are made of a harder material. Alternately, the entire holdable device may be made of the same material or materials, or different portions may be made of differing materials and differing numbers of material layers.

The holdable device finger lengths may be 5 mm to 500 mm, with a preferred length of 12 mm to 25 mm for the shorter fingers, and 25 mm to 50 mm for the longer fingers. The holdable device may be hollow, formed from two or more layers of material with one or more layers of air between them, or it may be solid, formed from one or more layers of material.

All of the embodiments discussed may be flavored, either infused with flavors or coated with flavors, either flavors containing sugar or sugar-free. For instance, for the first embodiment, the entire tapered cylinder may be flavored with a cherry flavor, or just the tip may be flavored. The flavor may be infused into the material of manufacture, and may be released through the biting process, or even by licking. Alternately, the tapered cylinder may be dipped into a container of flavor or the flavor may be coated onto the tapered cylinder. Medicines may be administered in a similar manner.

Any of the embodiments may be heated or chilled. For instance, the tapered cylinder may be frozen and then placed in the baby's mouth to help numb the baby' s gums. It may be heated to facilitate the release of flavoring or medication before placing in the baby's mouth.

Any of the embodiments may have a vibrating component. For instance, the tip may contain a component that allows a vibration, either to soothe the baby or to aid in dispensing medication. Alternately, the entire tapered cylinder may vibrate. The vibration rate may be fixed or variable, and may be controlled through an on-off switch. The entire device of the holdable device may vibrate, or selected components may vibrate. The battery may be internal or external to the holdable device.

For all of the embodiments, any combination of textures may be used, and any part or all of the device may have a texture or textures. The textures are generally raised portions of the material surface, although they can be indented portions as well.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An article of manufacture, comprising:
a tapered cylinder;
said tapered cylinder having a closed end and an open end;
said tapered cylinder having an inner surface and an outer surface wherein said outer surface has a texture;
said tapered cylinder being comprised of a material, wherein said material is impervious to the forces imposed by biting;
and said material securely adheres to a finger.

2. The article of claim 1, wherein said material is flexible.

3. The article of claim 1, wherein said material is ethylene vinyl acetate.

4. The article of claim 1, wherein said closed end has a tip.

5. The article of claim 4, wherein said tip is rectangular-shaped.

6. The article of claim 4, wherein said tip is triangular-shaped.

7. The article of claim 4, wherein said tip is circular-shaped.

8. The article of claim 4, wherein said tip vibrates.

9. The article of claim 4, wherein said tip is comprised of multiple layers of material.

10. The article of claim 1, wherein said tapered cylinder is comprised of two layers of material with water disposed between the layers.

11. The article of claim 1, wherein said tapered cylinder is formed from multiple layers of material.

12. The article of claim 1, wherein said tapered cylinder is approximately 5 to 6.5 centimeters in length.

13. The article of claim 1, wherein said tapered cylinder is approximately 4 to 7.5 centimeters in length.

14. The article of claim 1, wherein said tapered cylinder has a diameter of approximately 2.5 centimeters.

15. The article of claim 1, wherein said texture is bristles.

16. The article of claim 1, wherein said texture is bumps.

17. An article of manufacture, comprising:
a set of tapered cylinders;
each tapered cylinder having a closed end and an open end;
each tapered cylinder having an inner surface and an outer surface wherein said outer surface has a texture;
each tapered cylinder being comprised of a material, wherein said material is impervious to the forces imposed by biting;
and said material securely adheres to a finger.

18. An article of manufacture, comprising:
a set of tapered cylinders joined by a sheath;
said sheath having an open end;
each tapered cylinder having an inner surface and an outer surface wherein said outer surface has a texture;
each tapered cylinder being comprised of a material, wherein said material is impervious to the forces imposed by biting;
and said sheath securely adheres to a hand.

19. An article of manufacture, comprising:
a holdable device with a hole in the lower third of the device and a plurality of fingers at the top of the device; said holdable device having a front side and a back side; each
side having a texture; and said holdable device being comprised of a material,
wherein said material is impervious to the forces imposed by biting.

20. The article of claim 19, wherein said plurality of fingers comprises fingers of differing lengths.

21. The article of claim 19, wherein said plurality of fingers comprises fingers of the same length.

22. The article of claim 19, wherein said device is comprised of two layers with water disposed between the layers.

23. An article of manufacture, comprising:
holdable device with a plurality of fingers at the top of the device; said holdable device having a front side and a back side; each side having a texture; and said holdable device having a device guard; and said holdable device being comprised of a material, wherein said material is impervious to the forces imposed by biting.

24. The article of claim 19, wherein said plurality of fingers comprises fingers of differing lengths.

25. The article of claim 19, wherein said device is comprised of two layers with water disposed between the layers.
